(19) United States
(12) Patent Application Publication
(10) Pub. No.: US 2026/0293871 A1
(43) Pub. Date: Oct. 1, 2026

(54) FLOTATION-ENABLED FISHING ROD PROTECTOR AND MEASURING DEVICE

(71) Applicant: Marc B Ginn, Sumrall, MS (US)

(72) Inventor: Marc B Ginn, Sumrall, MS (US)

(21) Appl. No.: 19/089,889

(22) Filed: Mar. 25, 2025

(51) Int. Cl. A01K 97/08

(52) U.S. Cl. CPC A01K 97/08

(57) ABSTRACT

The present disclosure provides a fishing rod holder comprising a triangular prism-shaped body with a hollow triangular prism-shaped casing having a non-slip surface coating. An internal tubular structure within the body is configured to store a fishing rod, with a shell of the internal tubular structure having a rigidity that prevents the stored fishing rod from being crushed. A buoyant material is positioned between the casing and the internal tubular structure, filling the space created between them. The body includes a plurality of markings on at least one side for measuring fish. The triangular prism shape allows for stackable storage of multiple fishing rod holders, while the buoyant material enables flotation if dropped in water. The buoyant material further serves as a flotation aid to swimmers or those accidentally immersed.

### FIELD OF INVENTION

The field of this invention is fishing equipment, more specifically floatable fishing rod holders.

### BACKGROUND

Portable fishing rod holders have long been a staple accessory for anglers seeking convenience and versatility in their fishing expeditions. These devices allow fishermen to securely transport rods from one location to another, including through unsteady maritime environments, without risking damage or loss of their most important angling equipment. Rod holders come in various designs, including case-based holders emphasizing total coverage and protection of the rod, clamp-on holders for boats or docks, and models with handles for ease of transport.

The evolution of portable fishing rod holders has been driven by the diverse needs of anglers across different fishing environments. Early designs were often simple and limited in their functionality, but modern holders have incorporated features such as ergonomic shapes, multiple rod capacities, and corrosion-resistant materials. These advancements have made portable rod holders suitable for a wide range of fishing techniques, from surf casting to ice fishing, and have contributed to their popularity among both casual and serious anglers.

Despite the widespread use of portable fishing rod holders, there remains room for improvement in their design and functionality. Some common challenges include stability in varying terrain or weather conditions, ease of transport, and compatibility with different rod types and sizes. Furthermore, in maritime environments densely constructed rod holders risk falling overboard and sinking, rendering retrieval difficult. As fishing practices evolve and new technologies emerge, there is an ongoing need for rod holders that can adapt to changing angler preferences and integrate with other fishing equipment.

The invention described herein is a multifunctional fishing rod holder incorporating a plurality of distinct features to facilitate the transport and protection of fishing rods during angling. Its triangular shape and nonslip surface allow it to be set or stacked many flat surfaces without sliding or jostling. An internal cavity substantially comprising buoyant material prevents the rod holder from sinking in the event that it falls into the water. This property further allows the rod holder to double as a flotation aid for swimmers. A ruler marked on one or more sides of the apparatus allows quick and easy measurement of an angler's catch. By incorporating these functions into a single apparatus, the invention unifies and simplifies necessary angling equipment without sacrificing utility.

### SUMMARY

An apparatus for the protection and transport of fishing rods in both maritime and terrestrial contexts is provided. In one aspect, the present invention is an apparatus that protects fishing rods from damage during transport. In another aspect, the present invention is a measuring device suitable for assessing the length of fish caught on expeditions, among other relevant objects. In yet another aspect, the present invention is a flotation device preventing fishing rods from loss if they happen to fall into deep waters. In still another aspect, the present invention is a flotation aid for users who fall into hazardous waters. Generally, the present invention is a fishing rod holder that unifies several useful functions in maritime and near-aquatic environments.

The apparatus comprises a triangular prism of dimensions appropriate for fitting a fishing rod. A substantial amount of the internal volume of the prism is filled with buoyant material to both prevent internal rattling of the fishing rod and ensure flotation in the event that the apparatus falls into the water. The rod enters the apparatus in one of the bases of the triangular prism (the “open end”) through an aperture in a cap on said open end. In a preferred embodiment, the cap is watertight but removable for maintenance of the device. In another preferred embodiment, a plurality of caps may fit upon the open end with differently sized apertures to securely fit different models of fishing rods.

The outside of the prism comprises a casing constructed of durable, nonslip, corrosion-resistant materials suitable for use in a maritime environment. Along at least one side of the apparatus is a sequential set of markings suitable for measuring the length of an object. In a preferred embodiment, the markings correspond with the imperial measurement system. In another preferred embodiment, the markings correspond with the metric system. In yet another preferred embodiment, both imperial and metric units are represented in the apparatus's markings. In still another preferred embodiment, the markings run parallel to the apparatus, from one base to the other. Generally, the markings are suitable for measuring a fish or other object of lesser length than the apparatus.

The buoyant material comprising a substantial fraction of the inside of the apparatus serves to ensure the flotation of the apparatus in adverse conditions. In the exemplary embodiment, the buoyant material comprises flotation foam; however, other buoyant materials suitable for ensuring flotation of the apparatus may be used without departing from the inventive disclosure. The buoyant material is crucial for the function of the invention; if the apparatus and the fishing rod it holds falls overboard, the buoyancy will facilitate its retrieval without necessitating diving. The apparatus's secondary purpose as a flotation aid for swimmer or those who have accidentally fallen overboard is a central safety feature in maritime environments, where adverse conditions can easily tire even strong swimmers.

Inside the triangular prism suspended by the buoyant material is an internal tubular structure comprising a rigid shell, filling material, and an internal cavity of dimensions appropriate for holding a fishing rod. In a preferred embodiment, the filling material is shock-absorbing in order to better protect a stored fishing rod from damage. The internal cavity is accessible via the open end, which comprises an aperture through which a fishing rod may be inserted for storage. In a preferred embodiment, the internal cavity is lined with waterproof material to prevent leakage and rot in the filling material in the event of submergence. In another preferred embodiment, the internal cavity runs along the entire length of the apparatus to best accommodate fishing rods of variable lengths.

The foregoing summary has outlined some features of the system and method of the present disclosure so that those skilled in the pertinent art may better understand the detailed description that follows. Additional features that form the subject of the claims will be described hereinafter. Those skilled in the pertinent art should appreciate that they can readily utilize these features for designing or modifying other systems for carrying out the same purpose of the system and method disclosed herein. Those skilled in the pertinent art should also realize that such equivalent designs or modifications do not depart from the scope of the system and method of the present disclosure. For instance, though depicted as a replacement for current fishing rod holders during transport, the invention can easily accommodate other long, thin articles useful in maritime settings, such as umbrellas.

Further, it should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF FIGURES

Non-limiting and non-exhaustive examples are described with reference to the following figures.

FIG. 1 illustrates a front and side angled view of the apparatus consistent with the principles of the present disclosure.

FIG. 2 illustrates a side view of the apparatus with parallel markings for the measurement of an adjacent object consistent with the principles of the present disclosure.

FIG. 3 illustrates a side cross-sectional view of the apparatus, including the internal tubular structure consistent with the principles of the present disclosure.

FIG. 4 illustrates a frontal view of the apparatus with a removable cap consistent with the principles of the principles of the present disclosure.

FIG. 5 illustrates a front and side angled view of the apparatus with a fishing rod inserted within consistent with the principles of the present disclosure.

FIG. 6 illustrates a view of the invention with a fishing rod inside floating in water consistent with the principles of the present disclosure.

FIG. 7 illustrates a flow diagram illustrating the method of utilizing the apparatus consistent with the principles of the present disclosure.

### DETAILED DESCRIPTION

In the Summary above and in this Detailed Description, and the claims below, and in the accompanying drawings, reference is made to particular features, including method steps, of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with/or in the context of other particular aspects of the embodiments of the invention, and in the invention generally.

The term “comprises” and grammatical equivalents thereof are used herein to mean that other components, ingredients, steps, etc. are optionally present. For example, an article “comprising” components A, B, and C can contain only components A, B, and C, or can contain not only components A, B, and C, but also one or more other components. As defined herein, the word substantial means more than half of the length. As will be evident from the disclosure provided, the present invention satisfies the need for a floatable fishing rod holder.

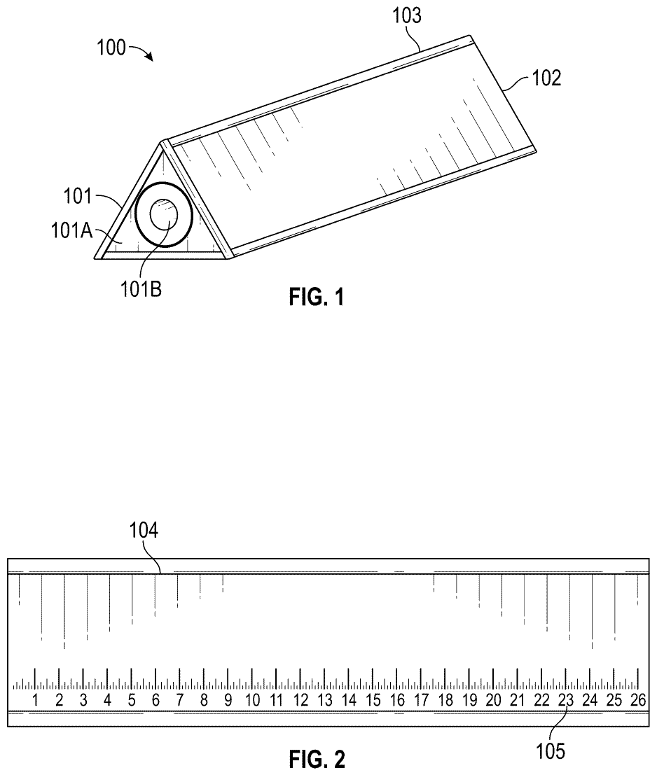

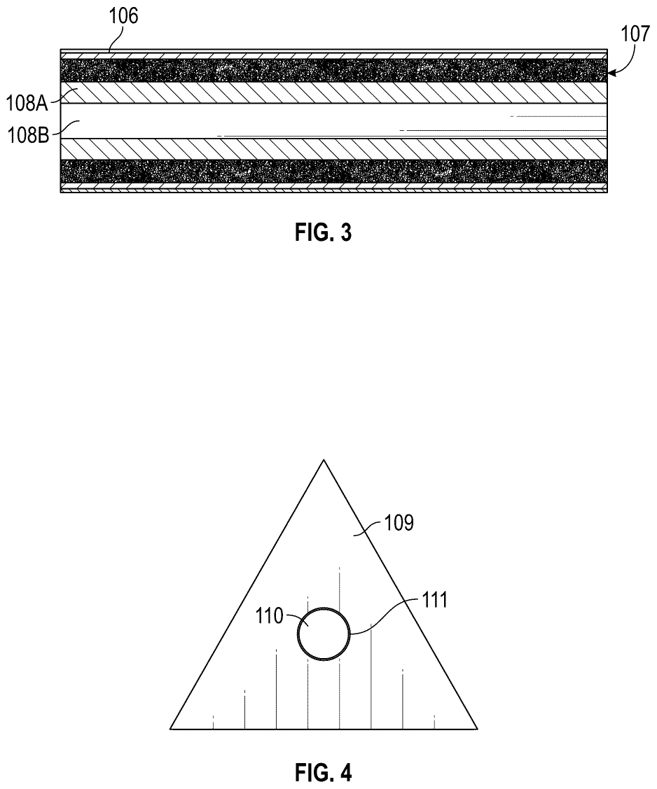

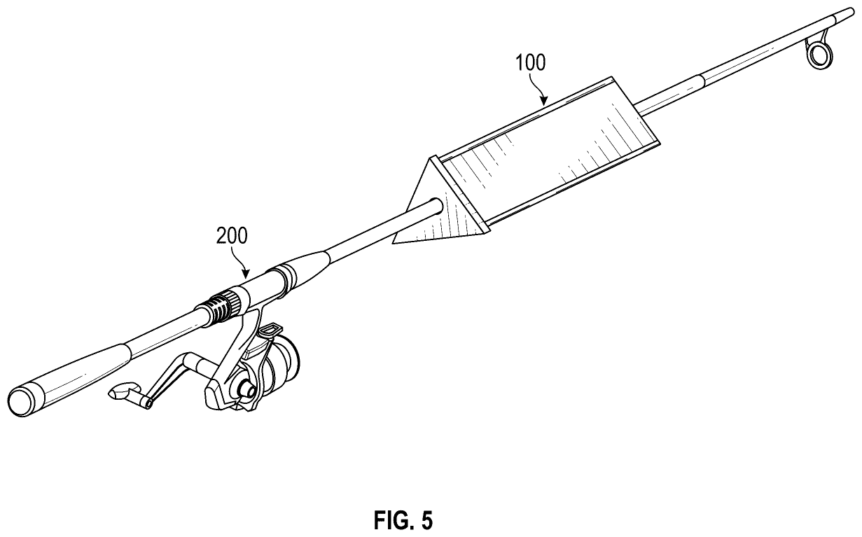

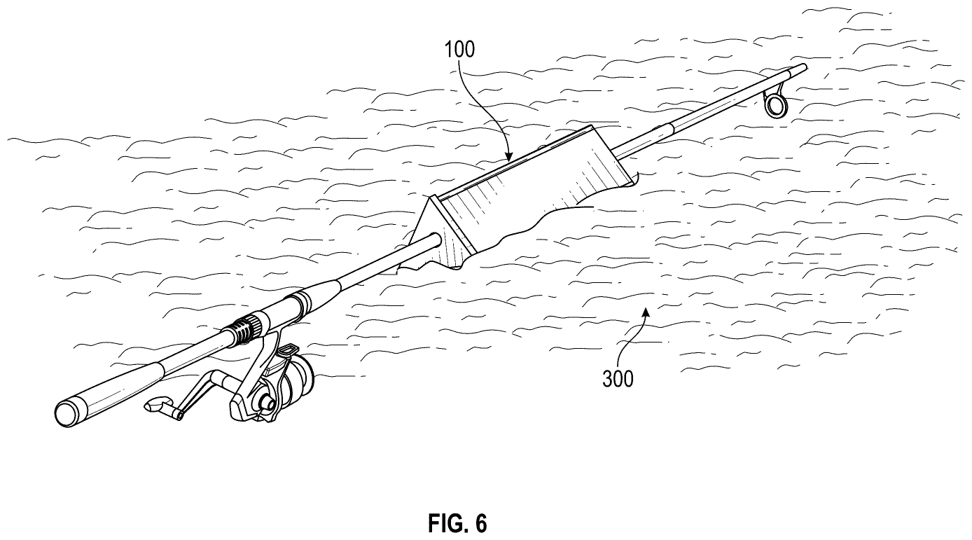

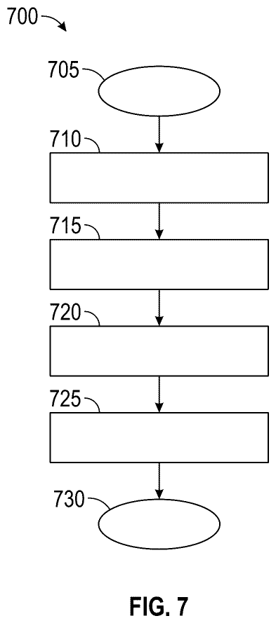

FIGS. 1-7 illustrate system of an action system 100 configured to reduce recoil and muzzle rise in a firearm as well as a method 700 of use. FIG. 1 illustrates a front and side angled view of the apparatus 100. FIG. 2 illustrates measurement side 104 of the apparatus. FIG. 3 illustrates a side cross-sectional view of the apparatus 100 with the differing layers of materials comprising the structure. FIG. 4 illustrates a frontal view of the apparatus 100 with removable cap 109. FIG. 5 illustrates the apparatus 100 with an exemplary fishing rod 200 inserted into the internal cavity 108B via the cap aperture 110 and face aperture 101B. FIG. 6 illustrates the apparatus 100 after being dropped or placed in the water 300. FIG. 7 illustrates a method of using the apparatus to store a fishing rod. It is understood that the various method steps associated with the methods of the present disclosure may be carried out as operations by the system 400 shown in FIGS. 1-6.

As illustrated in FIG. 1, the front and side angled view shows the disclosed triangular prism shape with at least one open end 101, non-measurement side 102, and top ridge 103. The open end 101 of the apparatus 100 preferably comprises an open-ended face 101A and face aperture 101B. In a preferred embodiment, the edges formed by the intersection of the sides and ends are sharply defined to reduce tumbling risks. In a distinct preferred embodiment, however, the edges are rounded or padded to reduce risk of injury. In another preferred embodiment, the top ridge 103 comprises an extendable handle to facilitate transport. The length of the apparatus 100 is of dimensions suitable to substantially hold the length of a fishing rod. In a preferred embodiment, the apparatus 100 is at least 2 feet long. However, other embodiments may comprise different lengths; one skilled in the art may manufacture an embodiment appropriate for longer or shorter fishing rods, depending on their intended style, space constraints, environment and number of open ends 101.

The triangular prismatic structure of the apparatus 100 is selected for maximal stability and resistance to tumbling or slippage. In a preferred embodiment, the triangular cross section of the apparatus 100 is equilateral. This design choice offers several advantages in the context of a fishing rod holder. The triangular shape contributes to the overall strength and rigidity of the structure. Triangles are inherently stable shapes in engineering, distributing forces evenly and resisting deformation. This property helps protect the fishing rod inside from external pressures or impacts, complementing the crush-resistant features of the crush-resistant shell 108A. The triangular shape provides three flat surfaces, allowing the apparatus to rest securely on any of its sides without rolling. This stability is particularly beneficial in maritime environments where movement and vibration are common, such as on boats or docks. The triangular cross-section also allows for efficient use of space when multiple rod holders are stored together, as they can be arranged in a compact, interlocking pattern. The equilateral triangular cross-section further enhances these benefits. With all sides of equal length, the apparatus maintains consistent stability regardless of which side it rests on. This uniformity simplifies use and storage, as there is no “correct” orientation for placing the rod holder. The equilateral design also ensures that when multiple holders are stacked, they align perfectly, maximizing storage efficiency and minimizing the risk of accidental displacement.

In a preferred embodiment, as illustrated in FIG. 2, the measurement side 104 comprises at least one set of measurement markings 105. The measurement markings 105 serve as a measuring device for fish caught by the user; however, they may be used to assess the spatial dimensions of any object without departing form the inventive subject matter. In a preferred embodiment, measurement markings 105 indicate length in the imperial measurement system, e.g., feet, inches, and fractions of an inch. In another preferred embodiment, the markings indicate length in the metric system, e.g., centimeters, millimeters, and meter(s). In yet another preferred embodiment, both imperial and metric units are represented on one side of the apparatus. In still another preferred embodiment, one side of the apparatus may have imperial units while another side has metric units. One skilled in the art will be able to utilize other systems of measurement, including nonstandard, novelty, or antiquated measurement systems, without departing from the subject matter described herein. In a preferred embodiment, the apparatus 100 comprises only one measurement side 104. In another preferred embodiment, however, apparatus 100 may comprise two or more measurement sides 104. In yet another preferred embodiment, each measurement side comprises measurement markings 105 belonging to different measurement systems.

In a preferred embodiment, the measurement markings 105 on the side of the apparatus run parallel to the length of the triangular prism. The markings preferably run the entire length of the apparatus, beginning at one end and terminating at the other to ensure maximal coverage of measurable objects. In yet another preferred embodiment, the apparatus includes an extendable ruler or roll of measuring tape built into one or more ends of the apparatus. Furthermore, there is considerable flexibility in determining how to apply the markings for measurement to the exterior casing. In a preferred embodiment, the markings are applied using a weather-resistant ink that contrasts with the color of the casing. In a related preferred embodiment, the markings are embossed upon the exterior of the casing. In some of these embodiments, the ink or paint is luminescent to facilitate measurement in low-light conditions. Similarly, in embodiments where texture is important, such as those designed for nearsighted users or for use in low-light conditions, the markings may be engraved into the surface of the casing. In another preferred embodiment, the markings are etched into the casing using acid or another corrosive material. When selecting methods for applying the measurement markings, one skilled in the art will take into account the properties of the base material and which methodologies will not compromise the durability or corrosion resistance of the casing.

As illustrated in FIG. 3, the exterior of the apparatus 100 preferably comprises a hollow casing 106 in the shape of a triangular prism. In a preferred embodiment, this casing 106 is the primary component of the apparatus 100, providing shape and stability. Furthermore, in most preferred embodiments, the exterior of the casing 106 is textured to reduce slippage. For example, the texture may include a raised pattern such as ridges, bumps, or crosshatching. In another preferred embodiment, the texture may be created by applying a rubberized coating or spray-on grip material. Another example may involve etching or sandblasting the surface to create a roughened texture. The texture could also incorporate non-slip materials-like silicone or rubber inserts-strategically placed on the exterior casing 106. In still another preferred embodiment, the texture may take the form of molded grooves or channels designed to channel water away and improve grip when wet. In yet another preferred embodiment, the molded grooves may be strategically placed to match the pattern of a hand gripping the apparatus 100. The specific texture chosen may depend on factors such as the primary use environment, manufacturing considerations, and user preferences. In yet another preferred embodiment, the casing incorporates reflective or luminescent properties to facilitate retrieval and visualization in low-light conditions.

Immediately within the apparatus 100, surrounded by the exterior casing 106, is a layer of buoyant material 107, wherein the buoyant material 107 is configured to fill the space between the exterior casing 106 and internal tubular structure 108. The primary function of buoyant material 107 is to lower the density in a way such that the apparatus may float in water. This ensures that if the fishing rod holder falls into water, it will float rather than sink, preventing loss of the fishing rod and facilitating retrieval. Furthermore, the buoyant properties of this material allow the apparatus to serve as an emergency flotation device for swimmers, contributing to the multifunctional nature of the apparatus 100 as a whole. In one preferred embodiment, the buoyant material 107 may also act as a shock absorber, reducing the amount of energy transferred from the exterior casing to the internal tubular structure. This helps protect the fishing rod stored inside from impacts or sudden movements. The buoyant material may also be designed with varying densities or compositions throughout its structure. For instance, areas near the edges or corners of the apparatus may have higher density or rigidity to provide additional impact protection, while the central areas may be softer to cushion the fishing rod.

In some preferred embodiments, the buoyant material 107 meaningfully contributes to the structural integrity of the apparatus. For instance, the buoyant material 107 may provide additional structural support to the apparatus, helping maintain its shape and integrity. Similarly, the buoyant material may be arranged to optimize the floating orientation of the apparatus if it falls into water, potentially comprising one or more materials of different densities to accomplish this aim. In embodiments incorporating components within the buoyant material itself, it contributes other functions. Depending on the material used, in some embodiments, the buoyant material 107 may offer some degree of thermal insulation, protecting the internal tubular structure and any components within the buoyant material from temperature fluctuations. The buoyant material may also be configured in a way that prevents water from entering the area that it fills when the apparatus is submerged. In a preferred embodiment, the buoyant material may be infused with antimicrobial agents to prevent the growth of mold, mildew, and bacteria, especially in humid marine environments. This may help maintain the hygiene and longevity of the apparatus. When contemplating variations upon embodiments of the invention, the buoyant material 107 is an ideal location for the addition of many features. In a preferred embodiment, a tracking device to facilitate the retrieval of lost rods may be localized within buoyant material 107, where it may be protected from damage by the buoyant material. For instance, the GPS device may be encased within a buoyant foam. In another preferred embodiment, the buoyant material includes embedded phase change materials (PCMs) that can absorb or release heat, helping to regulate the internal temperature of the apparatus and protect sensitive fishing equipment from extreme temperature fluctuations. In yet another preferred embodiment, the buoyant material may include channels or cavities that can be filled with additional buoyant substances as needed, allowing users to adjust the flotation characteristics of the apparatus based on the weight of the fishing rod or other contents.

Within the body of the apparatus 100, preferably surrounded by buoyant material 107, is an internal tubular structure comprising a rigid, crush-resistant shell 108A and an internal cavity 108B. The rigid shell 108A supports the overall structure of the apparatus 100 and adds an additional layer of protection to the fishing rod. The cavity 108B is the primary compartment in which a fishing rod or similarly shaped object is stored. In a preferred embodiment, the cavity 108B of the tubular structure 108 is lined with cushioning and shock absorbing material so that sudden movement does not risk damaging the rod within. In another preferred embodiment, this material is waterproof or nonporous to ensure that moisture does not infiltrate and lead to the growth of harmful, foul-smelling, or unsightly fungi. In the exemplary embodiment, the buoyant material 107 serves as the primary support for the internal tubular apparatus. However, this is not true of all potential embodiments: struts or supports may stabilize the internal tubular apparatus by linking it with the exterior casing. What this technique sacrifices in buoyancy it may improve in stability. Other embodiments may develop this further into a honeycombing structure of internal supports where the spaces are filled with buoyant material. One skilled in the art will use their best judgment to assess the necessity of support against buoyancy prior to manufacture.

In the exemplary embodiment of FIG. 1-6, the internal cavity 108B of the internal tubular structure is singular, cylindrical, and accessible via the face aperture 101B of the apparatus 100. However, this is not the case in all embodiments. In a preferred embodiment, the internal cavity 108B is segregated by permanent dividers into sub-compartments suitable for holding more than one fishing rod at a time. In another preferred embodiment, the internal cavity 108B contains notches which hold removable dividers, allowing the user to customize the cavity to their needs. In still another preferred embodiment, the internal cavity 108B is a triangular prism in place of a cylinder; alternatively, it is a rectangular prism or another shape. In yet another preferred embodiment, there is not a singular open end 101 of the apparatus: both ends are accessible via a removable cap 109 of identical dimensions. Such an embodiment might make use of a removable cap lacking an aperture to cover the end not in use holding a fishing rod. Alternatively, such an embodiment might use a second removable cap containing an aperture and utilize it to store a second fishing rod. In either case, the use of aperture-containing or aperture-lacking removable caps on the non-open end is fully within the scope of the inventive disclosure.

As illustrated in FIG. 4, the removable cap 109 comprises a generally triangular shape designed to fit about the body of apparatus 100, typically connecting at the exterior casing 106. Removable cap 109 further comprises a cap aperture 110 with nonslip lining 111. When removable cap 109 is affixed to open end 101 of apparatus 100, the cap aperture 110 is configured upon removable cap 109 such that the cap aperture 110 substantially aligns with the face aperture 101B. The primary function of the removable cap is to protect buoyant material 107 from damage, dirt, and water infiltration. Furthermore, the cap aperture 110 with nonslip lining 111 provides a narrowed entrance through which a fishing rod may be threaded into internal cavity 108B. The narrowing reduces rattling of the fishing rod about the internal cavity 108B and cap aperture 110. In a preferred embodiment, a plurality of appropriate removable caps is manufactured with slightly different dimensions of the cap aperture 110, allowing a user to select a cap that best fits their equipment.

The design of the cap-to-body 100 interface may include features such as threaded connections, snap-fit mechanisms, or compression fittings to ensure a secure attachment. In some embodiments, additional sealing methods like O-rings or custom-molded seals may be employed to further enhance the watertight properties of the closure. In a preferred embodiment, the cap includes a secondary ridge, seal, flange and/or flange receptacle corresponding with the internal tubular apparatus. In this embodiment, these features help ensure a watertight seal between the removable cap and the internal tubular apparatus, preventing water from entering the compartment containing buoyant material and causing corrosion or fungal growth. The specific choice of materials and sealing methods for the removable cap will depend on factors such as the intended use environment, manufacturing considerations, and the overall design of the fishing rod holder. In a preferred embodiment, the open end of the apparatus comprises a permanent, watertight covering that extends from the exterior casing to the outer edge of the internal tubular structure. Such a covering may be made of durable, corrosion-resistant materials appropriate for use in a maritime setting; when installed, it partially obviates the need for a watertight seal between the removable cap and the internal tubular apparatus, the exterior casing, or both.

FIGS. 5-6 illustrate the apparatus 100 in use. With the fishing rod 200 inserted into the internal cavity 108B via the cap aperture 110 and face aperture 101B, the apparatus may be transported at the user's leisure, as illustrated in FIG. 5. In a preferred embodiment, an inflatable air bladder is coupled to the exterior of removable cap 109 and attached to a water detection device and a compressed air canister. Upon submergence, as illustrated in FIG. 6, the water detection device triggers the compressed air canister, which inflates the air bladder to provide additional flotation. Generally, upon submergence the apparatus 100 is designed to prevent the contents of internal cavity 108B from sinking and furthermore serves as supplementary flotation to anyone accidentally submerged.

The materials from which the apparatus is constructed are selected due to their properties amidst a wide variety of considerations, such as density, durability, corrosion resistance, coefficients of friction, and cost. In a preferred embodiment, materials comprising the hollow triangular prism-shaped casing prioritize durability, corrosion-resistance, and suitability for maritime environments. These could include marine-grade plastics such as ABS (Acrylonitrile Butadiene Styrene), polypropylene, or high-density polyethylene (HDPE). These materials offer good resistance to saltwater and UV radiation while remaining relatively lightweight. In a preferred embodiment, composite materials like fiberglass can be molded into the required shape and offer good corrosion resistance and durability to the casing. Similarly, another preferred embodiment utilizes carbon fiber in its casing for its exceptional strength-to-weight ratio and corrosion resistance. In still another preferred embodiment, bamboo treated for water resistance offers buoyancy, strength, renewability for the environmentally conscious user, and a unique aesthetic appeal.

In some preferred embodiments, certain metals are highly suitable for the exterior casing of the apparatus. Aluminum alloys are particularly suitable for the casing, as they are generally lightweight, corrosion-resistant, and durable. Marine-grade aluminum alloys like 5052 or 6061 may be particularly suitable. While heavier than aluminum, stainless steel is highly corrosion-resistant and strong; grades like 316 or 316L are often used in marine applications. In a preferred embodiment, titanium substantially comprises the casing due to its corrosion resistance and high strength to weight ratio, thereby justifying its expense. Copper-based alloys like brass and bronze are frequently resistant to corrosion in saltwater settings. Brass in particular may develop a patina over time that can provide additional protection against degradation. Bronze is similar to brass in corrosion resistance, with some alloys specifically designed for marine use.

The surface coating of the exterior casing plays a key role in the function of the casing. In multiple preferred embodiments, the casing is coated or treated to improve corrosion resistance, durability, and slip resistance. In one such preferred embodiment, the non-slip surface coating on the exterior of the casing is achieved using rubberized paints, textured polymer coatings, or spray-on rubber compounds. These materials can provide grip even when wet, enhancing the holder's stability on various surfaces. In embodiments wherein the casing comprises one or more metals, nitriding or anodizing the surface may improve their corrosion resistance and durability. In another preferred embodiment prioritizing cost-effective measures, ordinary paint suitable for maritime environments is used on the surface, improving corrosion resistance while doing little to alter durability.

The internal tubular structure plays a crucial role in protecting the fishing rod from external forces and potential damage. This is particularly important in maritime environments where the rod holder may encounter rough handling, impacts from other equipment, or compression from stacking. In multiple preferred embodiments, the internal tubular structure comprises rigid materials such as PVC pipe, fiberglass tubing, or aluminum tubing, the structure can effectively resist deformation and crushing, even when subjected to significant external pressures. PVC pipe offers excellent corrosion resistance and is relatively lightweight, making it a cost-effective option for the internal structure. Fiberglass tubing provides superior strength-to-weight ratio and is highly resistant to both corrosion and UV radiation, ensuring long-term durability in various environmental conditions. Aluminum tubing, while slightly heavier than the other options, offers exceptional strength and heat dissipation properties, which can be beneficial in protecting sensitive fishing rod components from temperature fluctuations. The choice of material for the internal tubular structure should be made in consideration with the overall design and intended use of the fishing rod holder. For instance, in applications where weight is a critical factor, such as in portable or handheld designs, fiberglass or PVC might be preferred. In scenarios where maximum strength is required, such as in holders designed for larger, heavier rods or for use in extreme conditions, aluminum tubing might be the optimal choice. Other rigid materials with good strength-to-weight ratios like carbon fiber may be contemplated and utilized by one skilled in the art without departing from the inventive subject matter.

The buoyant material filling the space between the casing and the internal tubular structure may comprise a variety of materials that offer buoyancy, water resistance, and shock absorption properties. In a preferred embodiment, the buoyant material comprises closed-cell foams such as polyethylene foam, EVA (Ethylene-Vinyl Acetate) foam, or polyurethane foam, all of which excel in those fields. Expanded polystyrene (EPS) foam is another closed-cell foam that is similarly corrosion-resistant, lightweight, durable, and insulating against both shocks and temperature. Since these foams are easily moldable and cost-effective, they are recommended for embodiments that prioritize cheap and easily produced manufacturing. In another preferred embodiment, the buoyant material comprises syntactic foam, which contains hollow microspheres embedded in a resin matrix. Similarly, hollow plastic beads are a lightweight alternative to foams, though depending on their size and the quality of the seal joining components of the apparatus they risk leaking out into the environment.

In some preferred embodiments, the buoyant material does not comprise rigid spheres or foams. For users preferring renewable components, the buoyant material may comprise cork, cork composites, or balsa wood. In such embodiments, it is recommended that the buoyant material be treated to resist rot and water infiltration to prevent degradation. Aerogel-based materials may be used in embodiments where buoyancy is prioritized over strength and shock absorbance. It is recommended that aerogel-based buoyant materials be treated with a strong chemical base such that hydrophilic aerogels have their hydroxyl groups replaced with aliphatic groups; this step will reduce the risk of catastrophic degradation upon exposure to moisture. In another preferred embodiment, gas-filled bladders or chambers provide cushioning, buoyancy, and insulation to the apparatus. In multiple preferred embodiments, the configuration and density of the buoyant material is adjusted to provide the desired level of flotation and protection for the fishing rod. For instance, the apparatus may have more buoyant materials arranged near the open end so that in the event of submergence the closed end sinks more readily, keeping the fishing rod pointed up to prevent it sliding out.

The removable cap plays a crucial role in protecting the contents of the fishing rod holder from water ingress and other environmental factors; the size of its aperture also allows a closer fit with the dimensions of the fishing rod to prevent dislodging. To ensure compatibility and durability, materials similar to those used for the casing are employed for the cap. In a preferred embodiment, these include marine-grade plastics like ABS, polypropylene, or HDPE, which offer excellent resistance to corrosion and UV radiation. In some embodiments, the cap may be constructed from composite materials such as fiberglass or carbon fiber, providing enhanced strength and durability. To achieve a watertight seal between the cap and the body of the rod holder, many preferred embodiments incorporate gaskets into the design. It is recommended that these gaskets be made from materials that maintain their flexibility and sealing properties even after prolonged exposure to marine environments. Silicone gaskets, for instance, offer excellent resistance to temperature extremes and maintain their elasticity over time, making them ideal for this application. Rubber gaskets, particularly those made from synthetic rubbers like EPDM (Ethylene Propylene Diene Monomer) or neoprene, provide good compression set resistance and resistance to wear.

FIG. 7 depicts a flowchart 700 illustrating certain preferred method steps that may be used to carry out the method of utilizing a triangular prism-shaped apparatus for the storage and protection of a fishing rod. Step 705 indicates the beginning of the method. In step 710, the user obtains a triangular prism-shaped apparatus comprising an exterior casing, an internal tubular structure with at least one internal cavity, an open end comprising at least one aperture through which said internal cavity is accessible, and internal buoyant material filling the space between said internal tubular structure and said exterior casing. In a preferred embodiment, the buoyant material comprises flotation foam. In another preferred embodiment, the internal tubular structure comprises a rigid shell to prevent crushing of the contents of the internal cavity. In still another preferred embodiment, at least one of the internal tubular structure and the buoyant material are shock absorbing.

A removable cap configured to fit about the open end of the apparatus and comprising at least one aperture is obtained in step 715. Crucially, the aperture of the removable cap must align with the aperture of the open end such that the area of the removable cap's aperture is substantially overlapping with the aperture of the open end. The removable cap is affixed to the open end in step 720. In a preferred embodiment, the cap when affixed forms a watertight seal with at least one of the exterior casing and the internal tubular structure. This feature is particularly important for embodiments in which one or more of the components of the apparatus is susceptible to water infiltration and mold growth. In another preferred embodiment, the cap's attachment to the apparatus is facilitated by magnetic attachment. In step 725, a fishing rod is inserted into the apertures of the removable cap and internal cavity such that the length of said rod is substantially within said internal cavity. Step 730 indicates the termination of the method.

The implementations set forth in the foregoing description do not represent all implementations consistent with the subject matter described herein but are examples consistent with the disclosed subject matter. Although variations have been described in detail above, other modifications or additions may be possible. In particular, further features and/or variations may be provided in addition to those set forth herein. For example, the implementations described above may be directed to various combinations and subcombinations of the disclosed features and/or combinations and subcombinations of several further features disclosed above. In addition, the logic flow depicted in the accompanying figures and/or described herein do not necessarily require the particular order shown, or sequential order, to achieve desirable results. It will be readily understood to those skilled in the art that various other changes in the details, materials, and arrangements of the parts and method stages which have been described and illustrated in order to explain the nature of this inventive subject matter may be made without departing from the principles and scope of the present disclosure.

1. A fishing rod holder, comprising:
a triangular prism-shaped body comprising:
a hollow triangular prism-shaped casing with a non-slip surface coating,
an internal tubular structure within said triangular prism-shaped body configured to store a fishing rod,
wherein a shell of said internal tubular structure has a rigidity that prevents said fishing rod stored within an internal cavity of said internal tubular structure created from being crushed;
a buoyant material positioned between said hollow triangular prism-shaped casing and said internal tubular structure,
wherein said buoyant material is configured to fill a space created between said hollow triangular prism-shaped body and said internal tubular structure; and
a plurality of markings on at least one side of said body for measuring fish.

2. The fishing rod holder of claim 1, wherein said triangular prism-shaped body has an equilateral triangular cross-section to allow for stackable storage of multiple fishing rod holders.

3. The fishing rod holder of claim 1, wherein said buoyant material comprises flotation foam.

4. The fishing rod holder of claim 1, further comprising a removable cap on at least one end of the body, wherein said cap is configured to cover an aperture of said internal tubular structure, wherein said aperture allows for insertion of said fishing rod into said internal cavity of the internal tubular structure.

5. The fishing rod holder of claim 4, wherein said removable cap forms a watertight seal with at least one of said body or said internal tubular structure.

6. The fishing rod holder of claim 1, wherein said buoyant material is shock absorbing such that an amount of energy transferred from said triangular prism-shaped body to said internal tubular structure is lessened.

7. The fishing rod holder of claim 1, wherein said hollow triangular prism-shaped casing is constructed of a corrosion-resistant material suitable for use in maritime environments.

8. A method of protecting and transporting a fishing rod, comprising steps of:
obtaining a fishing rod holder having a triangular prism-shaped body comprising a hollow triangular prism-shaped casing, an internal tubular structure, and buoyant material,
wherein said buoyant material is positioned between said hollow triangular prism-shaped casing and said internal tubular structure,
wherein said buoyant material is configured to fill a space created between said hollow triangular prism-shaped casing and said internal tubular structure,
wherein a shell of said internal tubular structure has a rigidity that prevents a fishing rod stored within an internal cavity of said internal tubular structure from being crushed,
obtaining a removable cap from said body of said fishing rod holder,
wherein said removable cap is configured to cover an aperture of said internal tubular structure,
wherein an aperture of said removable cap comprises dimensions suitable for the insertion of a fishing rod,
wherein said aperture of said removable cap is aligned with said aperture of said internal tubular structure when said removable cap is attached to said body,
wherein said aligned apertures allows for insertion of said fishing rod into the internal cavity of the internal tubular structure,
attaching said removable cap to said body of said fishing rod holder; and
inserting said fishing rod into said fishing rod holder.

9. The method of claim 8, wherein said triangular prism-shaped holder has an equilateral triangular cross-section to allow for stackable storage of multiple fishing rod holders.

10. The method of claim 8, wherein said buoyant material comprises flotation foam.

11. The method of claim 8, wherein said removable cap forms a watertight seal with at least one of said body or said internal tubular structure.

12. The method of claim 8, wherein said hollow triangular prism-shaped casing has a non-slip surface coating.

13. The method of claim 12, wherein the exterior covering of said hollow triangular prism-shaped casing has a non-slip surface coating.

14. A flotation-enabled fishing equipment system, comprising:
a triangular prism-shaped rod holder having an internal tubular structure for storing a fishing rod and a triangular prism-shaped casing;
wherein a shell of said internal tubular structure has a rigidity that prevents a fishing rod stored within an internal cavity of said internal tubular structure from being crushed when an external force is applied to said triangular prism-shaped casing,
wherein an external surface of said triangular prism-shaped casing has a non-slip surface coating,
a buoyant material configured to fill a space created between said triangular prism-shaped casing and said internal tubular structure; and
a removable cap removably secured to at least one end of said triangular prism-shaped body,
wherein said removable cap is configured to cover an aperture of said internal tubular structure,
wherein said aperture allows for insertion of said fishing rod into said internal cavity of said internal tubular structure.

15. The flotation-enabled fishing equipment system of claim 14, wherein said triangular prism-shaped rod holder has an equilateral triangular cross-section to allow for stackable storage of multiple rod holders.

16. The flotation-enabled fishing equipment system of claim 14, wherein said buoyant material comprises flotation foam.

17. The flotation-enabled fishing equipment system of claim 14, wherein said removable cap forms a watertight seal with at least one of said body or said internal tubular structure.

18. The flotation-enabled fishing equipment system of claim 14, wherein said buoyant material is shock absorbing such that an amount of energy transferred from said triangular prism-shaped body to said internal tubular structure is lessened.

19. The flotation-enabled fishing equipment system of claim 18, wherein said casing is constructed of a corrosion-resistant material suitable for use in maritime environments.
